(19) United States
(12) Patent Application Publication
(10) Pub. No.: US 2004/0211327 A1
(43) Pub. Date: Oct. 28, 2004

(54) Machine for bundling branches and other yard waste

(76) Inventor: Michael Bock, Houston, TX (US)

Correspondence Address: James D. Petruzzi, Suite 745, 4900 Woodway, Houston, TX, 77056, US

(21) Appl. No.: 10/421,026

(22) Filed: Apr. 22, 2003

(51) Int. Cl. B65B 13/00; B30B 9/30; A01F 15/14; B65B 13/24; B65B 13/22

(52) U.S. Cl. 100/8; 100/29; 100/32

(57) ABSTRACT

A machine for bundling tree branches and other yard waste comprising a frame having at least two cradling arms of various configurations, and a crushing arm pivotally attached to the frame for pressing down the branches or yard waste. A preferred embodiment includes a binding or crushing arm comprised of rigid or flexible material and can be manipulated about the pivot point in a manner, which crushes or compacts and facilitates bundling of the waste. A preferred embodiment includes the flexible material is comprised of high tensile strength polymer or natural fibers such as natural or manmade rope. An alternative embodiment includes wheels attached to the frame bottom to facilitate movement of the machine and/or a twine holder for tying the waste. A preferred embodiment teaches the use of binding or crushing arm(s) or bungee cords to manipulate the waste to facilitate bundling.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of yard maintenance equipment and more specifically to a machine for bundling branches and other yard waste.

Many present day municipalities require bush and tree branches and yard waste to be bundled and curbed to facilitate pick up. Some cities' municipal waste departments are prohibited by ordinance from picking up waste that is not bundled or tied. Other regulations may limit the number of bundles that will be picked up, making crushing compacting and reducing the number of bundles advantageous.

Further, many home owners and yard maintenance workers find that bundled tree branches and yard waste eases the pick-up and transport process.

It is an advantage of the present invention to ameliorate the problems presented in the prior art and present a cost efficient and easy to use machine and process to crush and compact yard waste. The actual bundling of such waste is accomplished by tying or wrapping the waste using a variety of materials as is well known by practitioners of the art.

While complicated systems may have been devised for bundling, with the exception of the manual method of laying the branches in a pile over the binding material, there has not been a low cost device to facilitate bundling.

### BRIEF SUMMARY OF THE INVENTION

The primary advantage of the invention is to provide a stable area to bundle tree branches and yard waste for pickup.

Another advantage of the invention is the invention comprises a frame which provides a stable working area, a large area for holding tree branches and other yard waste and one or more arm(s) which create an open or solid cradle for the waste.

Another advantage of the invention is one or more crushing arms attached to the arm(s) or the frame by means of a pivot point.

A further advantage of the invention is to provide an easy and efficient way to bundle branches and yard waste for pickup, as many municipalities require such waste to be bundled prior to pickup.

Other advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a machine for bundling tree branches and other yard waste having a frame with at least two cradling arms and a crushing arm pivotally attached to the frame for pressing down the branches or yard waste.

In accordance with a preferred embodiment of the invention, there is disclosed a machine for bundling tree branches and other yard waste having a frame, a cradle stably attached to the frame for cradling branches, and a rigid binding arm pivotally attached to the frame for crushing the branches.

In accordance with another preferred embodiment of the invention, there is disclosed a machine for bundling tree branches and other yard waste having a frame, a first generally U-shaped arm on one side of the frame, a first arm mounted on the opposite end of the frame from the U-shaped cradle, a second arm pivotally attached to the frame opposite the first arm wherein the first arm and the second arm form a second U-shaped arm wherein the second arm is capable of crushing branches placed on the U-shaped arms.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a side plan view of an embodiment of the invention.

FIG. 2 is a side plan view of another embodiment of the invention.

FIG. 3 is a side plan view of another embodiment of the invention.

FIG. 4 is a side plan view of still another embodiment of the invention.

FIG. 5 is a side plan view of an alternative embodiment of the invention.

FIG. 6 is a side plan view of an alternative embodiment of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

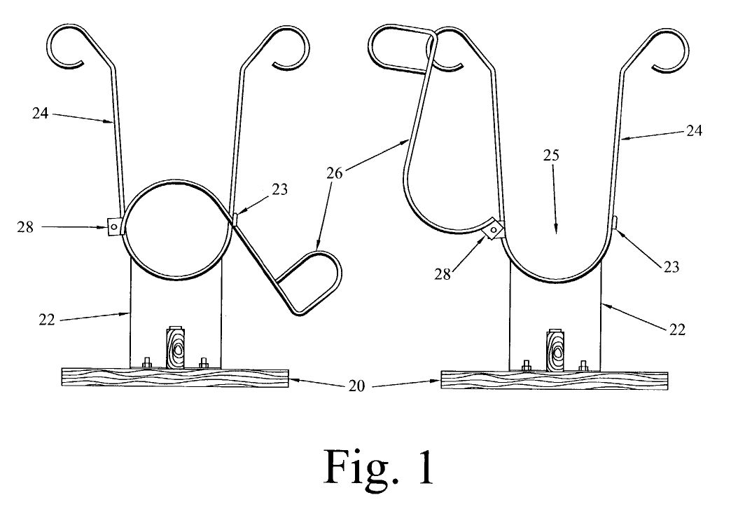

Turning now to FIG. 1, there is shown an embodiment of the invention. Frame 20 includes two supports 22 positioned on opposite ends of frame 20. Supports 22 provide a stable working area whereby two unshaped arms 24 create an open or solid cradle like space 25 for bush or tree branches and other yard waste. Arms 24 may also be of a variety of configurations such as a “v,” square, or rounded so long as they provide appropriate locations to lay yard waste and branches for bundling. Additional arms may be employed to cradle the branches or alternatively, the cradle could be a lattice of suitable material or a continuous cradle sufficient to hold yard waste. One or more binding or crushing arm(s) 26 is attached to arm(s) 24 or the frame by means of a pivot point 28. The binding or crushing arm(s) 26 can be held in the closed position by using a latch or hook (not shown) at the attachment point 23 on the arm 24 when the binding or crushing arm(s) 26 is in the closed position. The waste in the cradle space 25 is thus crushed and compacted and can be bundled with twine, cord, twist ties, string, rope or in any variety of ways as is well known in the art.

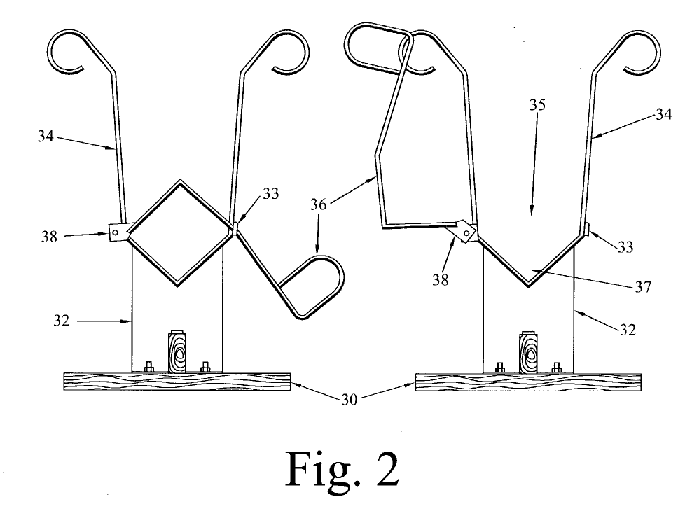

FIG. 2 shows an alternate embodiment of the invention. Frame 30 includes one or more supports 32 and provides a stable working area whereby one or more arms 34 create a cradle space 35 for tree branches and other yard waste. Alternatively, cradle space 35 may be formed by a series of parallel arms or a generally solid structure forming a cradle or holder for the yard waste. One or more binding or crushing arm(s) 36 is attached to the arm(s) 34 or the frame by means of a pivot point 38. The binding or crushing arm(s) 36 can be held in the closed position by using a latch or hook (not shown) at the attachment point 33 on the arm 34 when the binding or crushing arm(s) 36 is in the closed position. The shape of the binding or crushing arm(s) 36 and the arms 34 is shown in a rectangular or square configuration 37 but may be modified to conform to any variety of geometric shapes such as a diamond, hexagon or parallelogram. These shapes can be fashioned to comply with the varying ordinances and requirements for bundling implemented by municipalities and waste disposal entities. The waste in the cradle space 35 is thus crushed and compacted and can be bundled in any variety of ways as is well known to practitioners of the art.

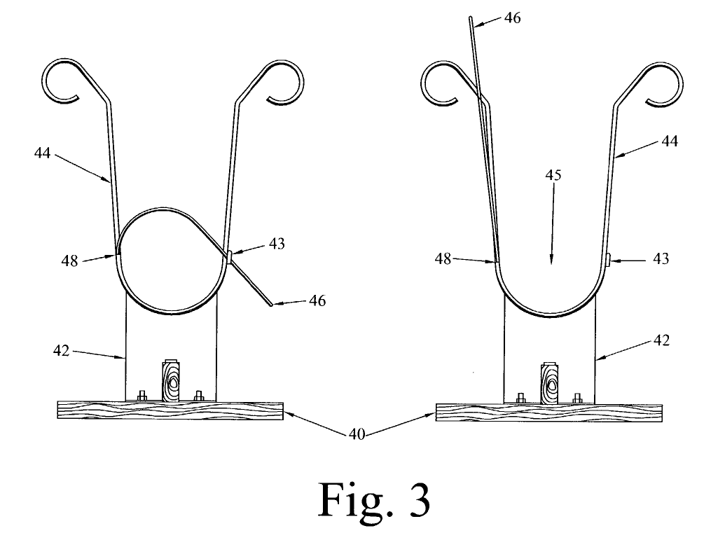

FIG. 3 shows an alternate embodiment of the invention. Frame 40 includes two supports 42 on opposite ends of frame 40 and provides a stable working area whereby one or more arms 44 positioned on top of supports 42 create an open or solid cradle like space 45 for tree branches and other yard waste. One or more flexible binding or crushing arm(s) 46 is attached to the shaped arm(s) 44 or the frame by means of a pivot point 48. The binding or crushing arm(s) 46 can be held in the closed position by using a latch or hook (not shown) at the attachment point 43 on the arm 44 when the binding or crushing arm(s) 46 is in the closed position. The composition of the binding or crushing arm(s) 46 may be flexible material such as metallic wire or high tensile strength polymer or natural fibers such as natural or manmade rope. The waste in the cradle space 45 is thus crushed and compacted and can be bundled in any variety of ways as is well known to practitioners of the art. A twine holder may be positioned between supports 42 for spooling around the crushed branches to facilitate tying of the refuse.

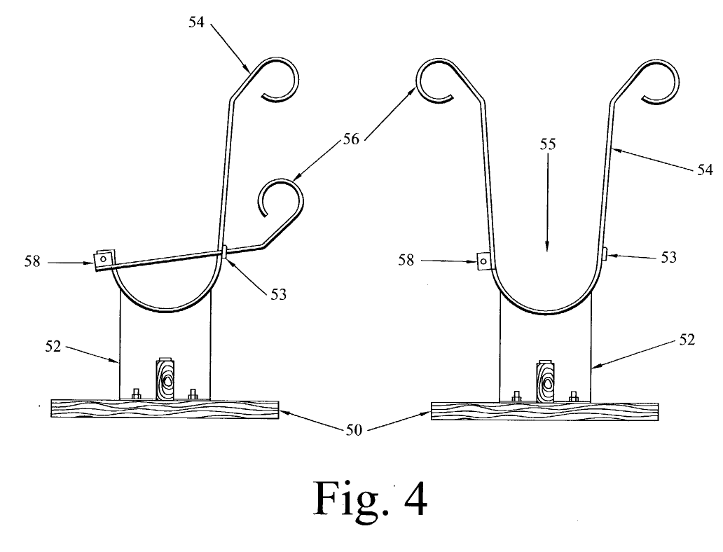

Turning now to FIG. 4 an alternative embodiment of the invention is shown. Frame 50 includes two supports 52 positioned on opposite ends of frame 50 and provides a stable working area whereby one arm 54 mounted on said support opposite pivoting arm 56 to create an open or solid cradle like space 55 for tree or bush branches and other yard waste. Arm 56 is attached to the lower portion of arm 54 by means of a pivot point 58. In this alternative embodiment the pivot point 58 is hinged and attaches the shaped arm 54 to the binding or crushing arm 56. The binding or crushing arm 56 can be held in the closed position by using a latch or hook (not shown) at the attachment point 53 on the shaped arm 54 when the binding or crushing arm(s) 56 is in the closed position. The waste in the cradle space 55 is thus crushed and compacted and can be bundled in any variety of ways as is well known to practitioners of the art.

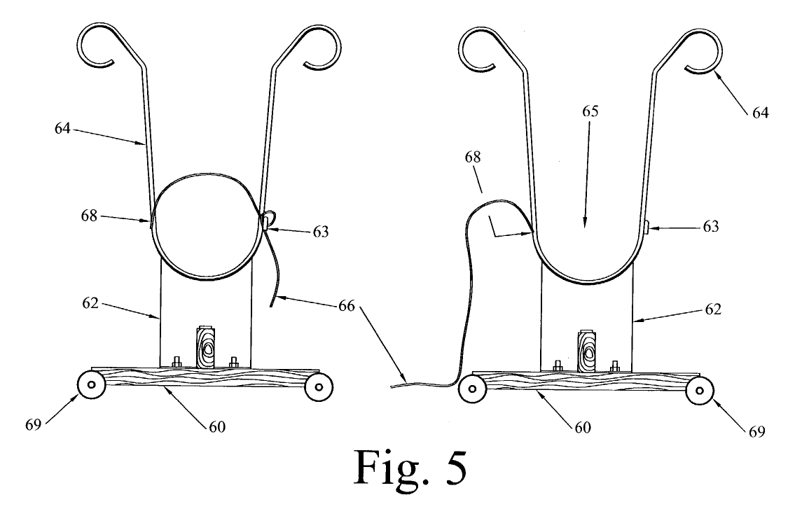

Turning now to FIG. 5 an alternative embodiment of the invention is shown. Frame 60 includes two supports 62 and provides a stable working area whereby one or more shaped arms 64 create an open or solid cradle like space 65 for tree branches and other yard waste. One or more flexible binding arm(s) 66 is attached to the shaped arm(s) 64 or the frame by means of a pivot point 68. The binding arm(s) 66 can be held in the closed position by using a latch or hook (not shown) at the attachment point 63 on the shaped arm 64 when the binding or crushing arm(s) 66 is in the closed position. The waste in the cradle space 65 is thus crushed and compacted and can be bundled in any variety of ways as is well known to practitioners of the art. The machine can be moved from one location to another utilizing the wheels 69 attached to the frame 60 bottom.

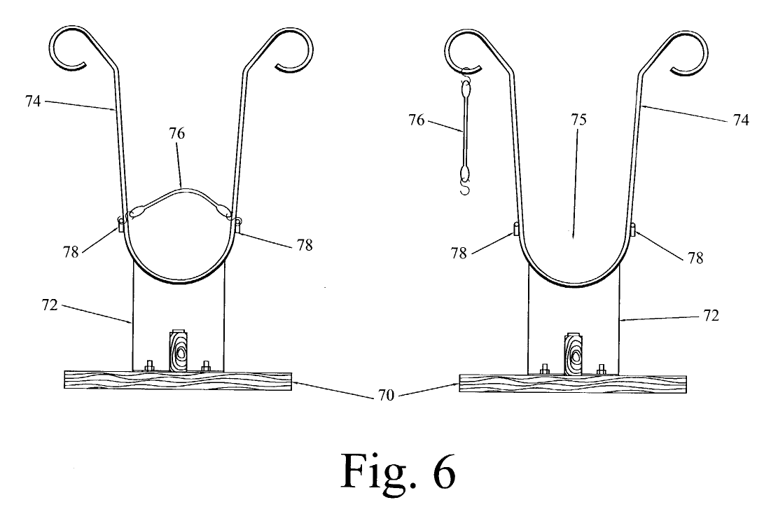

FIG. 6 shows an alternative embodiment of the invention. Frame 70 includes two supports 72 and provides a stable working area whereby one or more shaped arms 74 are mounted on said supports to create an open or solid cradle like space 75 for tree branches and other yard waste. Attachment points 78 on the shaped arm 74 secure “bungee” style tie down cord 76 and crush or bind the waste located in the cradle space 75. The waste in the cradle space 75 is thus crushed and compacted and can be bundled in any variety of ways as is well known to practitioners of the art.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A machine for bundling tree branches and other yard waste comprising:
a frame having at least two cradling arms; and
a crushing arm pivotally attached to said frame for pressing down said branches or yard waste.

2. A machine for bundling tree branches and other yard waste as claimed in claim 1 wherein said cradling arms are positioned on opposite ends of said frame.

3. A machine for bundling tree branches and other yard waste as claimed in claim 1 wherein said cradling arms are U-shaped.

4. A machine for bundling tree branches and other yard waste as claimed in claim 1 wherein said crushing arm is comprised of flexible material and can be manipulated about the pivot point in a manner which crushes and facilitates bundling of the waste.

5. A machine for bundling tree branches and other yard waste as claimed in claim 1 wherein said crushing arm is attached to one of said cradling arms.

6. A machine for bundling tree branches and other yard waste as claimed in claim 4 wherein said flexible material is comprised of high tensile strength polymer.

7. A machine for bundling tree branches and other yard waste as claimed in claim 4 wherein said flexible material is comprised of metal.

8. A machine for bundling tree branches and other yard waste as claimed in claim 4 wherein said flexible material is comprised of twisted fibers.

9. A machine for bundling tree branches and other yard waste as claimed in claim 1 further comprising a frame with wheels attached to the bottom of the frame to facilitate moving the machine close to the tree branches or yard waste.

10. A machine for bundling tree branches and other yard waste comprising:
a frame;
a cradle stably attached to said frame for cradling branches; and
a rigid binding arm pivotally attached to said frame for crushing said branches.

11. A machine for bundling tree branches and other yard waste as claimed in claim 10 wherein said cradle is comprised of two curved arms positioned on opposite ends of said frame.

12. A machine for bundling tree branches and other yard waste as claimed in claim 10 wherein said curved arms are U-shaped.

13. A machine for bundling tree branches and other yard waste as claimed in claim 10 wherein said binding arm is comprised of flexible material and can be manipulated about the pivot point in a manner which crushes and facilitates bundling of the waste.

14. A machine for bundling tree branches and other yard waste as claimed in claim 10 wherein said binding arm is attached to one of said curved arms.

15. A machine for bundling tree branches and other yard waste as claimed in claim 13 wherein said flexible material is comprised of high tensile strength polymer.

16. A machine for bundling tree branches and other yard waste as claimed in claim 13 wherein said flexible material is comprised of metal.

17. A machine for bundling tree branches and other yard waste as claimed in claim 13 wherein said flexible material is comprised of twisted fibers.

18. A machine for bundling tree branches and other yard waste as claimed in claim 10 further comprising a frame with wheels attached to the bottom of the frame to facilitate moving the machine.

19. A machine for bundling tree branches and other yard waste comprising:
a frame;
a first generally U-shaped arm on one side of said frame;
a first arm mounted on the opposite end of said frame from said U-shaped cradle;
a second arm pivotally attached to said frame opposite said first arm wherein said first arm and said second arm form a second U-shaped arm wherein said second arm is capable of crushing branches placed on said U-shaped arms.

20. A machine for bundling tree branches and other yard waste as claimed in claim 19 where said first U-shaped arm is comprised of two curved members mounted on opposite sides of one end of said frame.
